(19) United States
(12) Patent Application Publication
(10) Pub. No.: US 2011/0100486 A1
(43) Pub. Date: May 5, 2011

(54) Water valve safety cover

(76) Inventors: Oliver Adair Brewton, III, Florence, SC (US); Jessica Lynn Brewton, Florence, SC (US)

(21) Appl. No.: 12/590,162

(22) Filed: Nov. 4, 2009

(51) Int. Cl. F16K 27/00

(52) U.S. Cl. 137/382

(57) ABSTRACT

A device for covering a water faucet handle, water valve, or water knob to deny access to infants, small children, and those lacking mental discernment. The cover is generally comprised of a bowl portion that is placed over a water faucet handle, water valve, or water knob. The bowl portion is attached to a mounting flange containing a plurality of holes to mount suction cups for adherence to a tub, shower, counter, or similar surface. The device generally features a slot in the lateral wall of the bowl to allow long valve handles to pass through, yet prevent them from being turned by infants. The bowl portion is generally removable using a plurality of spring fingers on the lateral bowl wall to catch on the flange base. The bowl portion may constitute a variety of shapes. An alarm is generally attached to the cover to alert one the cover has been moved. Adherence of this device does not generally require drilling or any other means that would deface the binding surface. This cover is universal in design working on virtually all water faucet handles, water valves, and water knobs.

### CROSS-REFERENCE TO RELATED APPLICATIONS

U.S. Pat. No. 3,940,196 issued to Ketchel
U.S. Pat. No. 5,263,853 issued to Pall
U.S. Pat. No. 5,956,808 issued to Tom
U.S. Pat. No. 6,145,534 issued to Romero
U.S. Pat. No. 6,205,598 issued to Black and Tobias
U.S. Pat. No. 6,889,394 issued to Guillen

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to water faucets, water valves, and water knobs commonly found in households. Each year many infants and small children suffer from scalding due to easy access to hot water valves and knobs leading to serious injury and even death. Even access to cold water valves may lead to drowning or hypothermia. Not only can physical injury result from valves or knobs being turned by small children, but excessive utility usage or property damage may arise as well leading to financial loss.

2. Prior Technology

Several devices have been proposed to prevent access to water knobs and valves. Examples of prior art include U.S. Pat. No. 3,940,196, issued to Ketchel, U.S. Pat. No. 5,263,853, issued to Pall, U.S. Pat. No. 5,956,808, issued to Tom, U.S. Pat. No. 6,145,534, issued to Romero, U.S. Pat. No. 6,205,598, issued to Black and Tobias, and U.S. Pat. No. 6,889,394, issued to Guillen.

### Deficiencies in Prior Technology:

The patent issued to Ketchel discloses a cabinet for enclosing the faucets of a bathtub having a spring loaded latch requiring an operating force of sufficient magnitude to prevent small children from operating the cabinet and operating the faucets. While this cabinet prevents access, it is bulky and does not adequately describe how it would be attached to the tub wall. In addition, the cabinet does not constitute an alarm for signaling the cover is open. Finally, the cabinet does not contain a slot to allow long valve handles to pass through.

The patent issued to Pall discloses a faucet cover safety device for preventing the unintentional maladjustment of a single lever faucet handle mounted on a wall comprises a faucet escutcheon plate for location between the faucet handle and the wall. The faucet escutcheon plate has an external perimeter along which is located a catch; and the faucet escutcheon plate has a centrally located opening through which the faucet handle protrudes. A bowl-shaped cover encloses the faucet handle, and a hinge for connecting the external perimeter to the bowl-shaped cover to the faucet escutcheon plate. The cover has a periphery along which is located a latch for mating engagement with the catch of the faucet escutcheon plate, for preventing the unintentional maladjustment of the faucet handle. While this device prevents access, the device may not work for all valve types and requires an escutcheon plate. In addition, the device does not constitute an alarm for signaling the cover is open or in use.

The patent issued to Tom discloses a removable apparatus used to cover a knob that includes and inner casing and an outer casing, both of which together form a collar that surrounds a portion of the knob and in so doing mechanically decouples a rotary motion that is applied to the cover from the knob. Disposed intermediate the inner casing and the outer casing is provided a latching mechanism, which secures a hinged door to the cover. Release of the latching mechanism requires a two-step procedure beginning with the simultaneous application of a sufficient vertical force applied to urge a pair of vertical slide members downward. The downward force must be maintained in order for the second step to be accomplished. After the pair of vertical slide members have been urged downwards, the application of a sufficient horizontal (sideways) force is applied to urge a horizontal slide member to move horizontally causing the release of the latching mechanism. Each of the three required forces are applied by a separate digit, preferably of the same hand. Upon release of the latching mechanism the hinged door is opened and the cover is readily removed from the knob. Application of the cover over the knob consists of first sliding the cover over the knob while the hinged door is open and then closing the hinged door when the cover is properly positioned about the knob. While this apparatus prevents access, the apparatus may not work for all valve types. In addition, the apparatus does not constitute an alarm for signaling the cover is open or in use.

The patent issued to Romero discloses a valve guard for a water faucet with a manually operated control valve. The guard has two substantially identical sections that when joined together in a closed position form a generally spherical surface with a lower cut off opening portion. A spring hinge joins the sections together at facing side edges to normally maintain the sections together in a closed position. A child has insufficient hand strength to pry the two joined sections apart while an adult may easy separate them. The guard is placed over the valve to be controlled with the opened lower portion first. Due to the exposed spherical shape of the closed guard enclosure and the flat bottom opening edge, the guard is difficult for small hands to grasp and when touched may freely rotate about the enclosed valve. The guard is sized relative to the valve structure to be protected. Thus, it may be fitted over the hot water control valve of a two control valve faucet or over the one control valve of a single control valve lever. The lifting of the in place closed guard valve structure can be prevented by selecting a lower opening size that is smaller than the lateral size of the enclosed covered valve. While this valve guard prevents access, the valve guard may not work for all valve types. In addition, the valve guard does not constitute an alarm for signaling the valve guard is open or in use.

The patent issued to Black and Tobias discloses a protective cover for water fixtures for covering knobs and spout of bathtub and shower water fixtures. The protective cover for water fixtures includes a valve cover portion. The valve cover portion has a front wall, a top wall, a bottom wall, a first side wall and a second side wall. The valve cover portion has an interior space. The top wall and the bottom wall each have a plurality of slots therein. A plurality of fastening means removably fastens the valve cover portion over the hot and cold water fixtures. Each of the fastening means generally is U-shaped and has a first leg, a second leg and a base member. Each of the first legs is coupled to a wall such that the second legs extend upwardly away from the base members. The fastening means is spaced such that the second legs may be removably inserted in the slots in the top and bottom walls of the valve cover portion. While this cabinet prevents access, it does not adequately describe how the U-shaped fastening means would be attached to the tub wall. The protective cover may not work for all valve types. In addition, the protective cover does not constitute an alarm for signaling the cover is open. Finally, the protective cover does not contain a slot to allow long valve handles to pass through. The patent issued to Guillen discloses a device for covering a water faucet handle, and thereby denying access to the handle by small children and others lacking the mental discernment to appreciate and consider the consequences of their actions. The device comprises a generally L-shaped mounting member that is placed over the faucet handle and attached to a structural wall, and a generally rectangular, box-member. The device is held in its closed and locked position by a pair of spring fingers, defined by two parallel notches in the lateral sidewalls of the cover, wherein the catch member, which is located on the terminal end of each spring finger, is engaged with a catch slot in the spring finger catch that is located on the mounting member. The device is opened by simultaneously applying a lateral force to both spring fingers and rotating the cover downward. While this device prevents access it is installed using adhesive material most likely leaving a sticky residue once removed or requires semi-permanent installation by defacing the tub or shower wall. The device may not work for all valve types. In addition, the device does not constitute an alarm for signaling the device is open. Finally, the device does not contain a slot to allow long valve handles to pass through.

The previous devices are not universal in their design and many of the water knob or water valve covers that must attach to a base do not adequately explain how they would adhere. Adherence of the devices to the tub, shower, counter, or other base may require defacing the surfaces. The devices are not universal for varying knob, valve, and handle types. Those that prevent valve turning do not typically account for a valve with long handles or valves with lever mechanisms. The designs are typically complex in nature and may not represent something that can be economically sold for public use. The devices are typically constructed of several pieces making them more complex. In addition, the water knob and water valve covers do not constitute an alarm to alert one the cover is open or has been moved.

### SUMMARY OF THE INVENTION

In view of the aforementioned disadvantages and lack of universality inherent in the known types of faucet knob covers and water valve covers now present in the prior art, the present invention provides a new protective cover. The primary purpose of the cover is to prevent access to residential water knobs and water valves. In addition, the present invention provides an alarm to alert one if access is achieved. The invention generally applies to residential or light commercial purposes.

An objective of this invention is to provide a device to cover water faucet knobs and handles in a bathtub, shower, or sink.

Another objective of this invention is to alert a responsible adult if the cover is removed.

Yet another objective of the invention is to provide a device that is easy to install and remove over an existing faucet handle and does not require defacement of the binding surface such as a tub wall or shower wall or dismantling of the water knob.

A further objective of the invention is to provide a device that is universal in nature and can be used for faucet handles of different sizes.

Finally, it is an objective of the invention to provide a device that is relatively inexpensive to produce and can be mass produced to protect many infants and small children.

The current invention discloses a device that meets the aforementioned objectives and others as will become readily apparent by the disclosure herein. The device of the current invention is comprised of a stationary flanged portion, which is attachable to a structural wall or surface by use of suction cups, and a removable or stationary bowl portion to cover the water knob or handle. A slot is generally located in the lateral wall of the bowl portion to allow a long valve handle to pass through. For the stationary bowl option, a responsible adult must release the vacuum from each suction cup and pull the cover outward for removal. For the removable bowl cover option, fastening devices are comprised of a plurality of spring fingers on the bottom of the bowl portion each including a catch member for insertion into the plurality of catch slots on the flanged portion. The cover is removed by manually applying inward force to the spring fingers and lifting the cover outward. An audible or visible alarm would alert the responsible adult the device had been moved or is in use. In addition, the audible alarm would generally frighten a small child to leave the area.

Various embodiments of the device can be used to cover different shapes. Once an activity such as adjusting the water temperature is complete, the responsible adult would either apply the suction cups of the flanged portion back to the binding surface such as the tub wall or place the cover back on using the spring finger latching mechanism.

Before explaining at least one embodiment of the invention in detail, it is to be understood that the invention is capable of taking on various embodiments and carried out various ways. The terminology and phraseology used herein are for the purpose of description and should not be regarded as limiting.

### BRIEF DESCRIPTION OF THE SEVERAL VIEWS OF THE DRAWING

The objects and features of the present invention, which is believed to be novel, are set forth in the appended claims. The present invention will be better understood and its advantages will become apparent to readers when referencing the following descriptions, taken in conjunction with the accompanying drawings, wherein:

FIG. 1 is a perspective view of the faucet knob or water valve cover of the current invention showing the cover mounted on a vertical wall.

FIG. 2 is a perspective view of the faucet knob or water valve cover of the current invention showing the cover mounted on a horizontal surface such as a tub surface.

FIG. 3 is a perspective view of the faucet knob or water valve cover of the current invention with the slot to allow long handles to pass through.

FIG. 4 is a perspective view of the cover showing the current invention in its closed position with the spring finger latch.

FIG. 5 is a perspective view of the faucet knob or water valve cover of the current invention with an alarm to alert one the cover is open or has been moved.

FIG. 6 is a cross-sectional view showing the operation of the spring finger latch as inward force is applied to the spring finger entering the catch slots shown in the plan view.

### DETAILED DESCRIPTION OF THE INVENTION

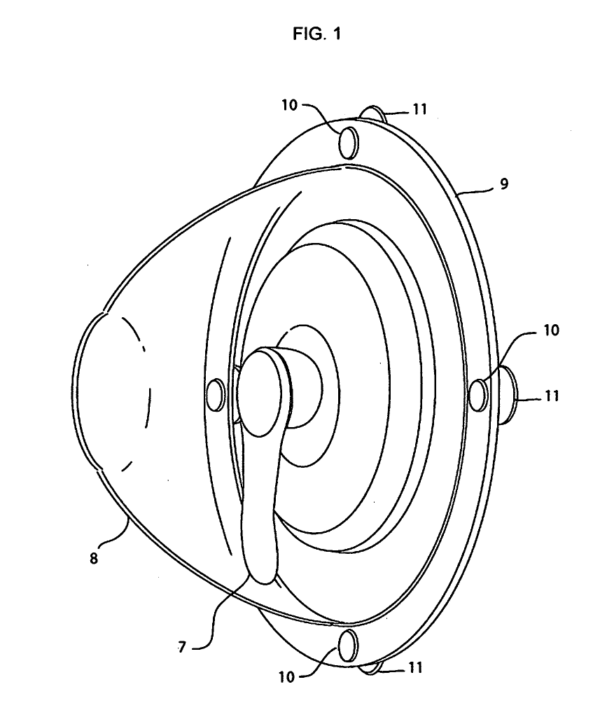

FIG. 1 is a perspective view of the water valve safety cover in the closed position over a water valve handle 7. The generally hemispherical shaped cover has a bowl portion 8 that is connected to a flanged portion 9 containing a plurality of holes 10 to allow for the attachment of suction cups 11, which adhere to the shower, tub, or similar surface by pressing the suction cups inward. In FIG. 1, the cover is mounted to a vertical shower surface.

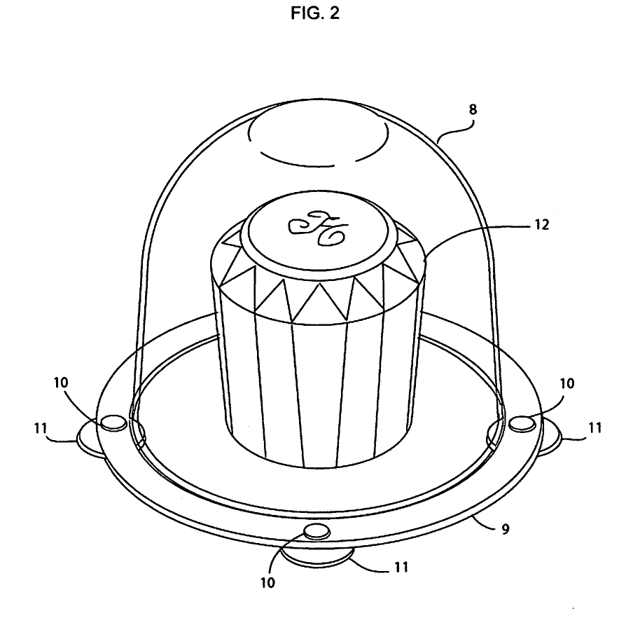

FIG. 2 is a perspective view of the water valve safety cover in the closed position over a water knob 12. The generally hemispherical shaped cover has a bowl portion 8 that is connected to a flanged portion 9 containing a plurality of holes 10 to allow for the attachment of suction cups 11, which adhere to the shower, tub, or similar surface by pressing the suction cups inward. In FIG. 2, the cover is mounted to a horizontal tub surface.

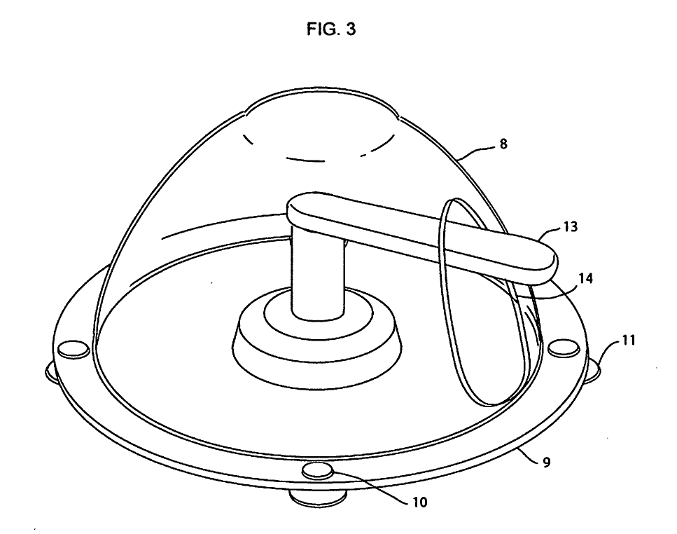

FIG. 3 is a perspective view of the water valve safety cover in the closed position over a long water valve handle 13. The generally hemispherical shaped cover has a bowl portion 8 that includes a slot 14 on the lateral wall to allow the long handle 13 to pass through. The bowl portion 8 is connected to a flanged portion 9 containing a plurality of holes 10 to allow for the attachment of suction cups 11, which adhere to the shower, tub, or similar surface by pressing the suction cups 11 inward. In FIG. 3, the cover is mounted to a horizontal tub surface.

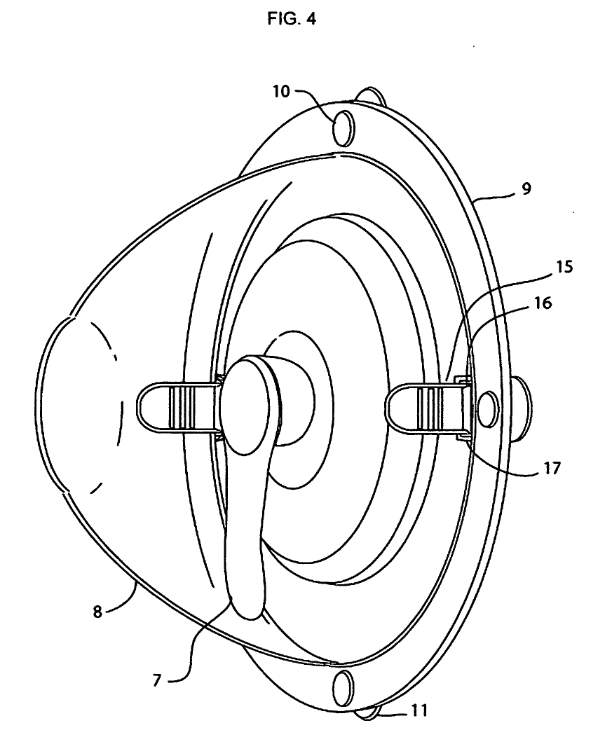

FIG. 4 is a perspective view of the water valve safety cover in the closed position over a water valve handle 7. The generally hemispherical shaped cover has a bowl portion 8 that includes a plurality of spring fingers 15 with each spring finger 15 including a catch member 16. The catch members 16 are inserted into the catch slot 17 of the flanged portion 9 thereby securing the bowl portion 8. The flanged portion 9 contains a plurality of holes 10 to allow for the attachment of suction cups 11, which adhere to the shower, tub, or similar surface by pressing the suction cups 11 inward.

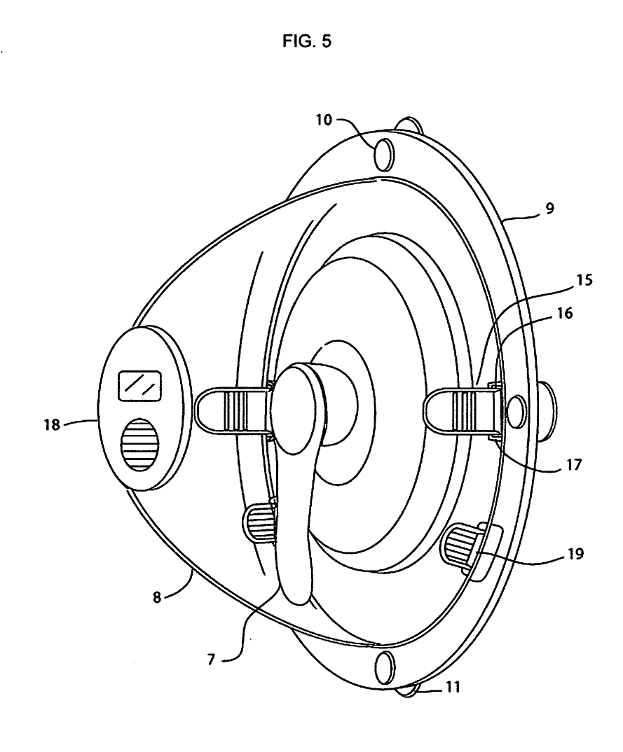

FIG. 5 is a perspective view of the water valve safety cover in the closed position over a water valve handle 7. The generally hemispherical shaped cover has a bowl portion 8 that includes a plurality of spring fingers 15 with each spring finger 15 including a catch member 16. The catch members 16 are inserted into the catch slot 17 of the flanged portion 9 thereby securing the bowl portion 8. The flanged portion 9 contains a plurality of holes 10 to allow for the attachment of suction cups 11, which adhere to the shower, tub, or similar surface by pressing the suction cups 11 inward. The cover includes an alarm 18 to alert a responsible adult the cover has been moved. In addition, the alarm 18 would generally frighten a small child to leave the area. Alarm contacts 19 would generally serve to activate the alarm. The alarm 18 may also be activated by movement or motion.

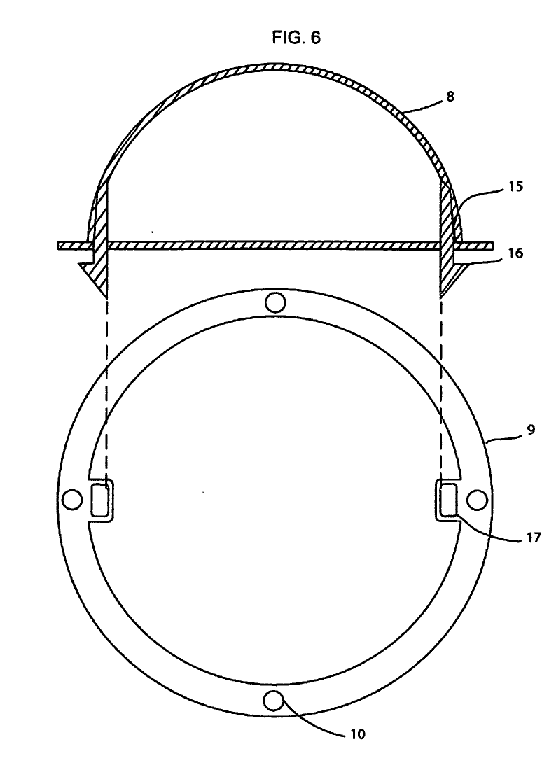

FIG. 6 is a cross-sectional view of the bowl portion 8 connected to the spring finger latch allowing the catch member 16 of the spring finger 15 to catch in the catch slot 17 of the flanged portion 9 shown in the plan view.

The bowl portion 8 and flanged portion 9 are generally constructed of a hard plastic material like, but not limited to PP (Polypropylene), ABS (Acrylonitrile-butadiene-styrene), HDPE (High-density Polyethylene). The bowl portion 8 is constructed of material having sufficient elastic memory such that when lateral force is removed, the spring fingers 15 will return to their original position allowing the catch members 16 to be engaged by the catch slots 17 and hold the bowl portion 8 in the closed position. The material also is hard enough to resist deformation such that a small child will not be able to generate enough force to disengage the catch member 16 from the catch slot 17 or deform the bowl portion to move the water valve handle 7. The suction cups 11 hold enough suction pressure to prevent a small child from removing the cover. The cover is also wide enough to prevent a small child from manipulating the plurality of spring fingers 15 with a single hand.

While a preferred embodiment of the water valve safety cover has been described in detail, it should be apparent that modifications and variations thereto are possible, all which fall within the true spirit and scope of the invention. With respect to the above description then, it is realized that the optimum dimensional relationships for the parts of the invention, to include, variations in size, materials, shape, form, function and manner of operation, assembly and use, are deemed readily apparent and obvious to one skilled in the art, and all equivalent relationships to those illustrated in the drawings and described are intended to be encompassed by the present invention. For example any suitable sturdy material such as metal, plastic, rubber, fabric, or a variety of wood may be used for the cover.

1. A cover for denying access to a water faucet handle, water valve, or water knob comprising; a flanged portion including a plurality of holes for installing suction cups; said flanged portion is connected to a bowl portion; said bowl portion is generally a hemispherical cover comprised of lateral side walls and a top wall; said bowl portion is placed over said water faucet handle, water valve, or water knob and secured to a surface using said suction cups.

2. The device of claim 1 wherein, said lateral walls contain a slot to allow a valve handle to pass through.

3. The device of claim 1 wherein, said cover comprised of said bowl portion and said flanged portion are constructed in a variety of shapes including, but not limited to a rectangular shape.

4. The device of claim 1 wherein, said bowl portion is removable using a plurality of spring fingers containing a catch member on the lateral wall that would catch on the said flanged portion containing a plurality of catch slots for securing the said spring fingers; said faucet handle cannot be manipulated until lateral force is simultaneously applied to the plurality of said spring fingers to deform inwardly thereby disengaging said catch members from said catch slots; the said bowl portion is removed.

5. The device of claim 1 further including an alarm attached to said cover to alert one that said cover has moved. Said alarm may be audible and or visible triggered by a plurality of means including but not limited to movement sensors, motion sensors, magnetic contacts, or metal to metal contacts.

6. A cover for denying access to a water faucet handle, water valve, or water knob comprising; a flanged connected to a bowl portion; said bowl portion is generally a hemispherical cover comprised of lateral side walls and a top wall; said bowl portion is placed over said water faucet handle, water valve, or water knob and secured to a surface using a plurality of fastening means.

7. The device of claim 6 wherein, said lateral walls contain a slot to allow a valve handle to pass through.

8. The device of claim 6 wherein, said cover comprised of said bowl portion and said flanged portion are constructed in a variety of shapes including, but not limited to a rectangular shape.

9. The device of claim 6 wherein, said bowl portion is removable using a plurality of spring fingers containing a catch member on the lateral wall that would catch on the said flanged portion containing a plurality of catch slots for securing the said spring fingers; said faucet handle cannot be manipulated until lateral force is simultaneously applied to the plurality of said spring fingers to deform inwardly thereby disengaging said catch members from said catch slots; the said bowl portion is removed.

10. The device of claim 6 further including an alarm attached to said cover to alert one that said cover has moved. Said alarm may be audible and or visible triggered by a plurality of means including but not limited to movement sensors, motion sensors, magnetic contacts, or metal to metal contacts.

11. The device of claim 6 wherein, said fastening means includes, but is not limited to suctions cups, adhesive leaving behind minimal residue, or caulking material.
